(19) United States
(12) Patent Application Publication
(10) Pub. No.: US 2025/0289692 A1
(43) Pub. Date: Sep. 18, 2025

(54) Lifting and/or Lowering and/or Compression Device Including an Electric Actuator and a Pneumatic Assist Actuator and Method of Lifting and/or Lowering and/or Compacting

(71) Applicant: JARP Industries, Inc., Schofield, WI (US)

(72) Inventors: Joseph W. Jackan, Eland, WI (US); Mitchell Baker, Marshfield, WI (US); Jacob Jackan, Chippewa Falls, WI (US); Logan Balliet, Hatley, WI (US)

(21) Appl. No.: 19/081,747

(22) Filed: Mar. 17, 2025

Related U.S. Application Data
(60) Provisional application No. 63/566,680, filed on Mar. 18, 2024.

(51) Int. Cl. B66C 23/00

(52) U.S. Cl. CPC B66C 23/54

(57) ABSTRACT

A lifting and/or lowering and/or compaction device provides repetitive actions. The lifting and/or lowering device includes: a tower assembly and a boom assembly extending from the tower assembly and configured to rotate relative to the tower assembly; an electric actuator assembly comprising an electric actuator housing body and an extension rod extending from the actuator housing body and configured to extend and retract from the actuator housing body, wherein the electric actuator assembly attaches to the tower assembly and the boom assembly to provide the rotation of the boom assembly relative to the tower assembly; and a pneumatic actuator assembly comprising a pneumatic actuator and a rod extending from the pneumatic actuator and configured to extend and retract from the pneumatic actuator, wherein the pneumatic actuator assembly attaches to the tower assembly and the boom assembly to provide rotation of the boom assembly relative to the tower assembly. The compaction device can include a moveable platform instead of a boom assembly, and the compaction device can lower or raise the moveable platform along an axis extending between a first location and a second location. A method of lifting and/or lowering and/or compacting includes actuating the electric actuator assembly and the pneumatic actuator assembly.

### CROSS-REFERENCE TO RELATED APPLICATIONS

This application claims priority to U.S. provisional patent application Ser. No. 63/566,680, filed on Mar. 18, 2024, to the extent appropriate; the disclosure of which is incorporated herein by reference in its entirety.

### FIELD OF THE DISCLOSURE

This disclosure relates to a lifting and/or lowering and/or compression device that includes a combination of an electric actuator and a pneumatic assist actuator, and to a method of lifting and/or lowing and/or compacting using a combination of an electric actuator and a pneumatic assist actuator to provide repetitive lifting and/or lowering and/or compacting.

### BACKGROUND OF THE DISCLOSURE

Hydraulic cylinder linear actuators dominate the high power, high life actuator field, notably in heavy mobile machinery. Hydraulic cylinders typically include a cylinder or barrel wherein a piston fixed to the end of a rod sits. The piston creates a seal with the barrel interior and is constructed to slide along the length of the barrel in one direction or the opposite direction to either extend or retract along the length of the cylinder. This is generally achieved by having each end of the barrel sealed, one end allowing the rod to slide freely therethrough, the piston being attached to the rod, and positioning two port openings on the respective sides of the piston, where hydraulic fluid is selectively forced through these port openings to move the piston. Depending on whether the piston and rod are going through extension or retraction, one port receives pressurized fluid that actuates the piston and rod that extends through the end of the sealed barrel and the other port permits fluid to flow out. The reverse alternatively occurs. This system requires a pump (gas or electric) to provide pressurized fluid, and a medium to transport the pressurized fluid (tubes and/or hoses). Even mildly complex systems generally use a subsystem of valves and/or regulators which are parasitic but protective in nature. Hydraulic fluid has exceptional lubricating qualities which in combination with polymer/composite seals, offers a very low friction and low wear system against the predominantly ferrous and chrome plated components of the cylinder.

Electric linear actuators typically utilize rotational bearings as a mode of actuation against a threaded or grooved rod which is powered by a local electric motor mounted externally. This provides direct metal to metal contact to transfer force and does not allow for the same level of wear resistance that a hydraulic system offers. This also has a tendency to restrict electric actuators from higher force applications because they lack the overall durability of certain hydraulic cylinder systems. Electric linear actuators have the advantage of being self-contained where there is no need for remote external components such as the pump and fluid reservoir in a hydraulic system, and this provides for a smaller overall footprint. With no large amount of fluid required for operation, there is also no risk for hazardous leaks and spills that may happen with hydraulic systems.

In repetitive, single-direction acting force applications (repetitive lifting and/or repetitive lowering), regenerative or energy storage systems have been implemented into hydraulic systems to increase efficiency. A bias to extend by an assistive separate spring-like system (pneumatic or physical spring) can relieve some or all of the tare weight of the apparatus.

US Patent Application Publication No. US 2007/0068754 A1 demonstrates an inclusive system where a traditional hydraulic cylinder is fitted with a hollow rod on the blind end that slides into the hollowed out rod attached to the piston. There are two closed systems that interact with the same dynamic rod. The hydraulic system is fundamentally unchanged whereas the pneumatic system includes a gas within the piston-rod assembly that acts as a gas spring when the gas is compressed or expanded.

U.S. Pat. No. 6,918,247 describes a system including a hydraulic cylinder and an assist cylinder that captures potential energy and then releases kinetic energy to provide an assist.

Energy recovery systems exist within hydraulics, but these still suffer from qualities of the hydraulic system including the complexity of the system, the need for external components such as a pump and fluid reservoir, and the risks of leaks or spills.

There remains a need for a biased system that utilizes an electric linear actuator system and that provides for a reduction in the energy required to conduct work thereby allowing the electric linear actuator to be used to move loads that it might not otherwise be rated for moving, and which extends the useful life of the electric linear actuator.

### BRIEF DESCRIPTION OF THE DRAWINGS

FIG. 1 is a front perspective view of a lifting and/or lowering device including an electric actuator assembly and a pneumatic assist actuator assembly according to the principles of the present disclosure.

FIG. 2 is a left side view of the lifting and/or lowering device of FIG. 1.

FIG. 2A is left side view of the lifting and/or lowering device of FIG. 2 except where the pneumatic assist actuator assembly 14 is in partial extension.

FIG. 2B is a left side perspective view of the lifting and/or lowering device of FIG. 2 except that the device includes a linkage 90.

FIG. 3 is a right side view of the lifting and/or lowering device of FIG. 1.

FIG. 4 is a top view of the lifting and/or lowering device of FIG. 1.

FIG. 5 is a rear perspective view of the lifting and/or lowering device of FIG. 1.

FIG. 6 is a bottom perspective view of the lifting and/or lowering device of FIG. 1.

FIG. 7 is a front view of the lifting and/or lowering device of FIG. 1.

FIG. 8 is a rear view of the lifting and/or lowering device of FIG. 1.

FIG. 9 is a side view of a first alternative embodiment of a lifting and/or lowering device including an electric actuator assembly and a pneumatic assist actuator assembly according to the principles of the present disclosure.

FIG. 10 is a perspective view of the lifting and/or lowering device of FIG. 9.

FIG. 11 is a side view of a second alternative embodiment of a lifting and/or lowering device including an electric actuator assembly and a pneumatic assist actuator assembly according to the principles of the present disclosure.

FIG. 12 is a perspective view of the lifting and/or lowering device of FIG. 11.

FIG. 13 is a side view of a third alternative embodiment of a lifting and/or lowering device including an electric actuator assembly and a pneumatic assist actuator assembly according to the principles of the present disclosure.

FIG. 14 is a perspective view of the lifting and/or lowering device of FIG. 13.

FIG. 15 is an illustration showing a fourth and fifth embodiment of a lifting and/or lowering device including an electric actuator assembly and a pneumatic assist actuator assembly according to the principles of the present disclosure.

FIG. 16 is a perspective view of a seventh embodiment of a lifting and/or lowering device showing an exemplary alternative arrangement of a secondary cylinder.

FIG. 17 is a perspective view of a sixth embodiment of a lifting and/or lowering device showing an exemplary alternative arrangement of a secondary cylinder.

FIG. 18 is a perspective view of an eighth embodiment of a compression lowering device according to the principles of the present disclosure.

FIG. 19 is a perspective view of the compression device according to FIG. 18.

### DETAILED DESCRIPTION

The disclosure relates to a lifting and/or lowering device that includes both an electric actuator assembly and a pneumatic assist actuator assembly, in combination with a boom, for lifting the boom through the application of force. The electric actuator assembly can be referred to more simply as the electric actuator. The pneumatic assist actuator assembly can be referred to more simply as the pneumatic actuator, as the pneumatic cylinder, or as the accumulator. In addition, the “lifting and/or lowering device” can be referred to more conveniently as a “lifting device” or as a “lowering device,” and those characterizations can be used interchangeably because the repetitive nature of the movement of, for example, a boom assembly is between a lifting operation and a lowering operation. The tare weight of the boom assembly, for example, will act as a load during both the lifting and the lowering operations. It should be appreciated that the tare weight refers to the portion of the boom assembly that contributes to or generates the weight that is moved during lifting and lowering. Furthermore, there may be applications where the lowering operation requires greater force than the lifting application, and the device used in such an application can be referred to as a lifting device even though a greater force may be used in the lowering operation. In addition, the disclosure relates to a compression device that may also be used for lifting and/or lowering, and may avoid the use of a boom.

The lifting device can be found on various devices including, for example, service cranes, utility trucks, etc., where there is a need to provide for repetitive load lifting and/or lowering, or in a factory or warehouse environment for repetitive load lifting and/or load lowering. As an example, the lifting device can be provided as a part of a stationary device and/or as part of a robotic device. Advantageously, the load can be a relatively constant load so that the lifting device can be configured to provide a repetitive lift and/or lowering of a relatively constant load. Typically, the loads for these types of applications may be either at the limit of commonly available electric actuator assemblies or beyond the limit of such available electric actuator assemblies. Furthermore, by utilizing the pneumatic cylinder, and selecting the proper arrangement for the pneumatic cylinder, it may be possible to utilize the electric actuator in situations that are typically reserved for hydraulic actuators. It should be understood that the phrase “constant load” refers to repetitive loads over a time period that relatively close to each other. For example, for a sample size of about 10 loads, a constant load may refer to about 75% of the loads being within about 25% of each other. Of course, the device would also be useful for loads that are not characterized as “constant loads.”

The electric actuator assembly can generally include a motor assembly attached to an actuator, a gearbox to transfer the motion of the motor assembly and convert rotational speed to provide an appropriate amount of torque to the actuator, and an extensible rod and cylinder assembly composed of a mounting structure pivotally mounted to a base of the crane or to another structure to provide advantage. In addition, the electric actuator assembly can include an additional mounting structure pivotally mounted to the boom of the crane. Also provided are a system for the reception of the torque applied by the gearbox situated at the base end of the actuator assembly, and a method of rod extension used to raise and lower the boom in accordance with the actuation of the motor. The electric actuator assembly provides for the use of an electric motor to raise and lower the boom of a crane while maintaining a simple and compact system of actuation.

By pairing the electric actuator assembly with a pneumatic assist actuator assembly, electric actuator assembly can be assisted to provide desired power or load that it might otherwise not be able to provide, and also utilize leverage to advantage. The pneumatic assist cylinder assembly can include one or more of extensible struts including a mounting structure mounted pivotally to the base of the crane or to another structure to provide advantage, an additional mounting structure mounted pivotally to the boom of the crane, a rod assembly positioned within a barrel housing, and an external reservoir to allow for the tuning of the pneumatic struts through the volume of the external reservoir. The pneumatic strut configuration can provide simple pneumatic power to assist the electric actuator in the raising and/or lowering of the crane. This pairing of the electric actuator assembly and the pneumatic assist cylinder assembly can permit the electric actuator assembly to be used for loads that are typically too much for the electric actuator assembly alone, and can also be used to permit a smaller electric actuator assembly to perform lift and/or lowering load that would otherwise require a larger or more powerful electric actuator assembly.

An example of a pneumatic assist cylinder or pneumatic actuator is illustrated in U.S. Pat. No. 11,493,060 and is characterized as an accumulator. The disclosure of the accumulator in U.S. Pat. No. 11,493,060 is incorporated herein by reference, and can be used herein as a pneumatic assist cylinder.

The lifting device can include a boom that moves to provide lifting and/or lowering of a load. By arranging the electric actuator and the pneumatic actuator in certain ways, it is possible to utilize the pneumatic actuator in a manner that assists the electric actuator when the load is the greatest. For example, when the electric actuator is fully retracted, the pneumatic cylinder can be utilized to provide maximum pressure thereby providing maximum assisting force. Furthermore, it is possible to locate the pneumatic actuator parallel with the electric actuator, and it is also possible to locate the pneumatic actuator so that it is not parallel with the electric actuator. By being non-parallel, it is possible to arrange the pneumatic assist actuator so that it can provide additional assistance at a particular point in the lifting and/or lowering sequence, and take advantage of leverage.

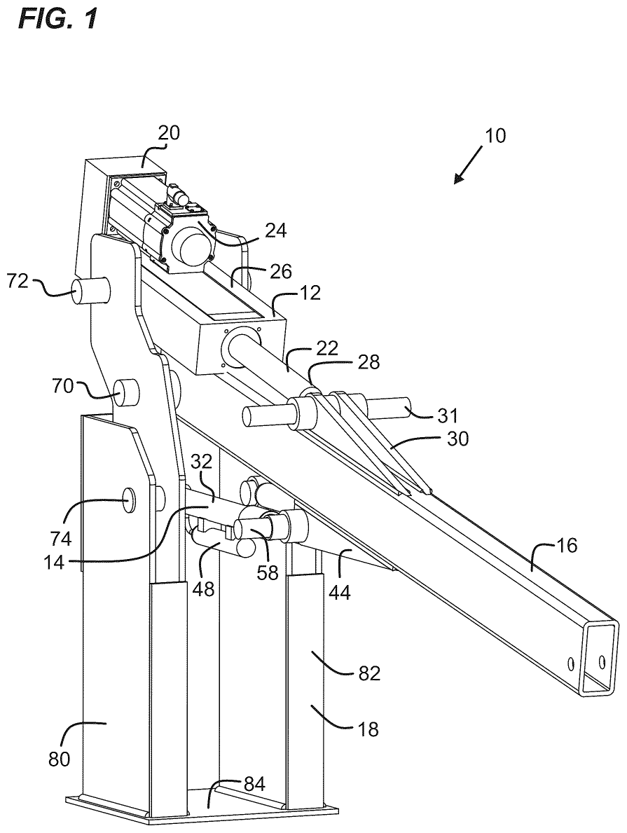

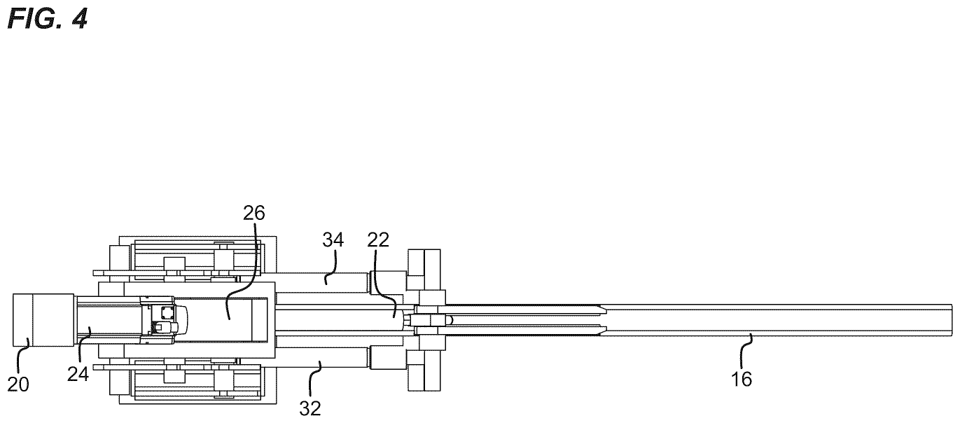

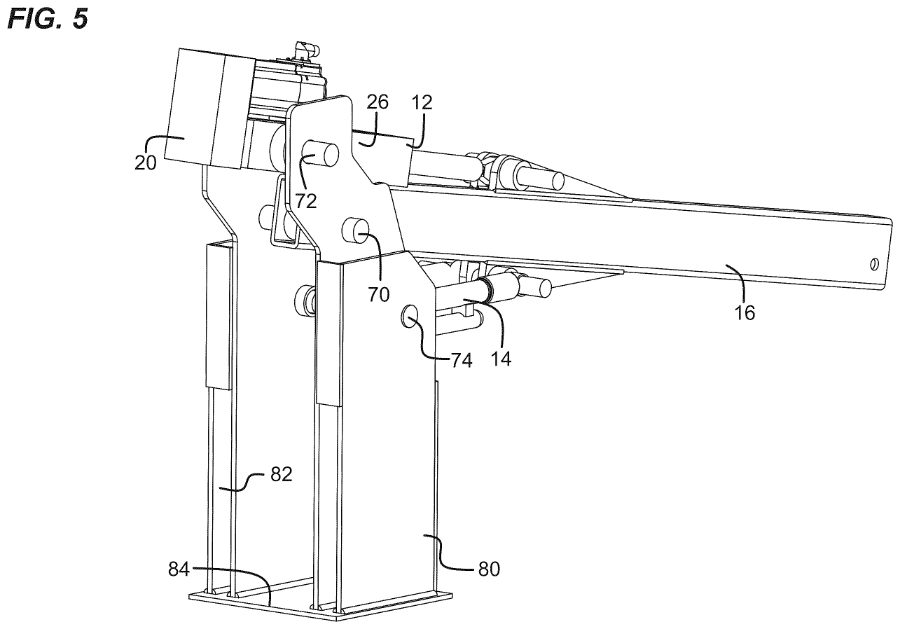

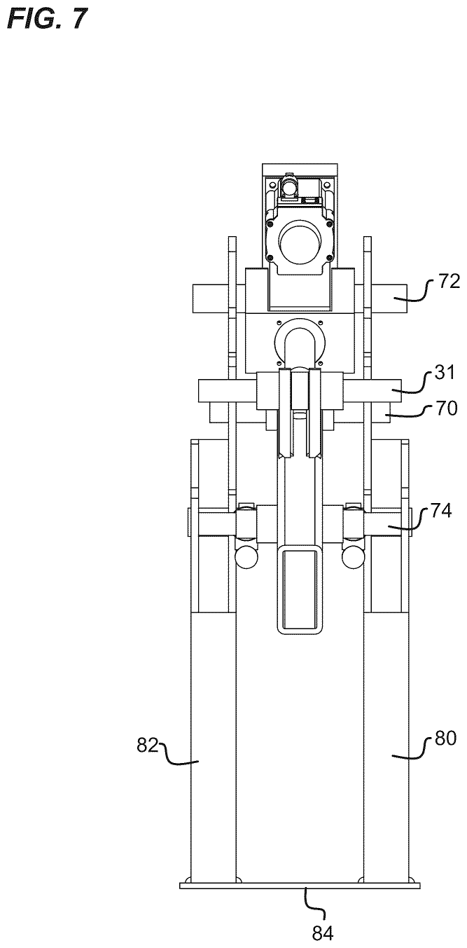

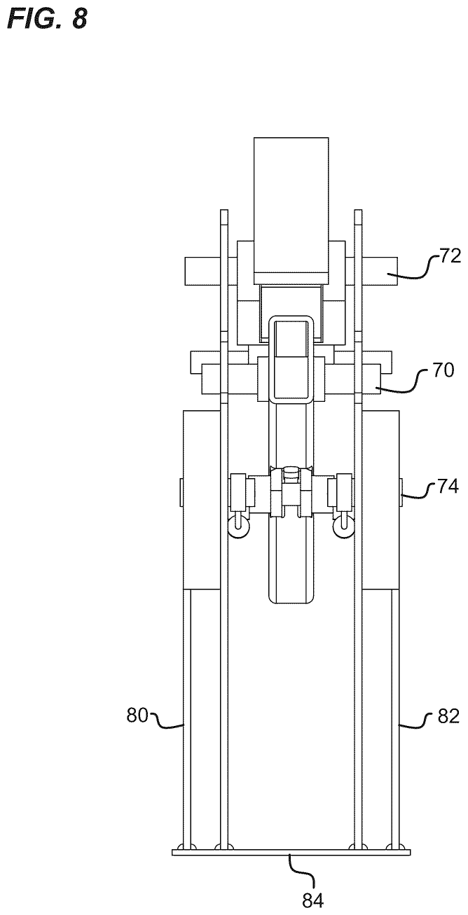

Now referring to FIGS. 1-8, a lifting and/or lowering device according to the present disclosure is illustrated at reference number 10. The lifting device 10 includes an electric actuator assembly 12, a pneumatic assist actuator assembly 14, a boom assembly 16, and a tower or support structure 18.

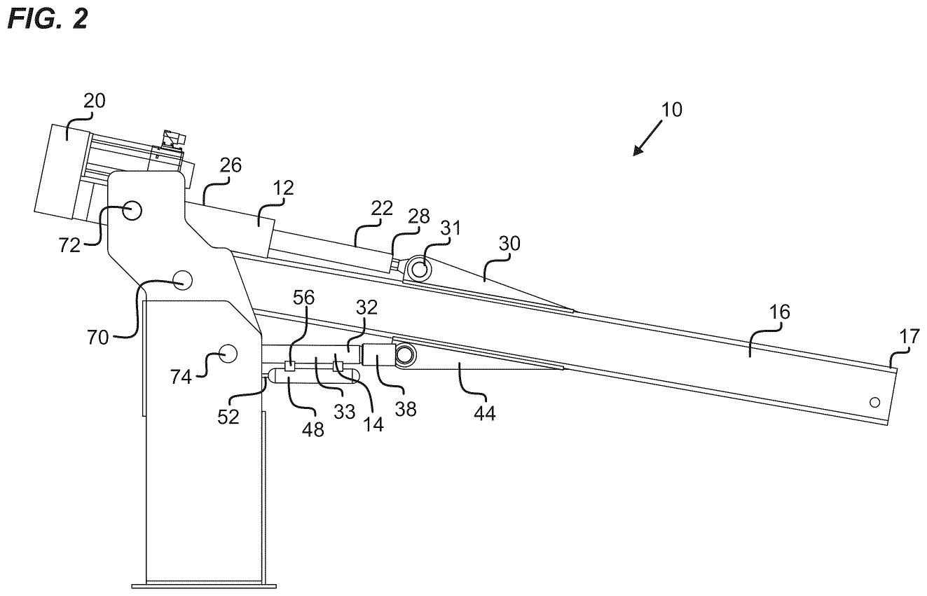

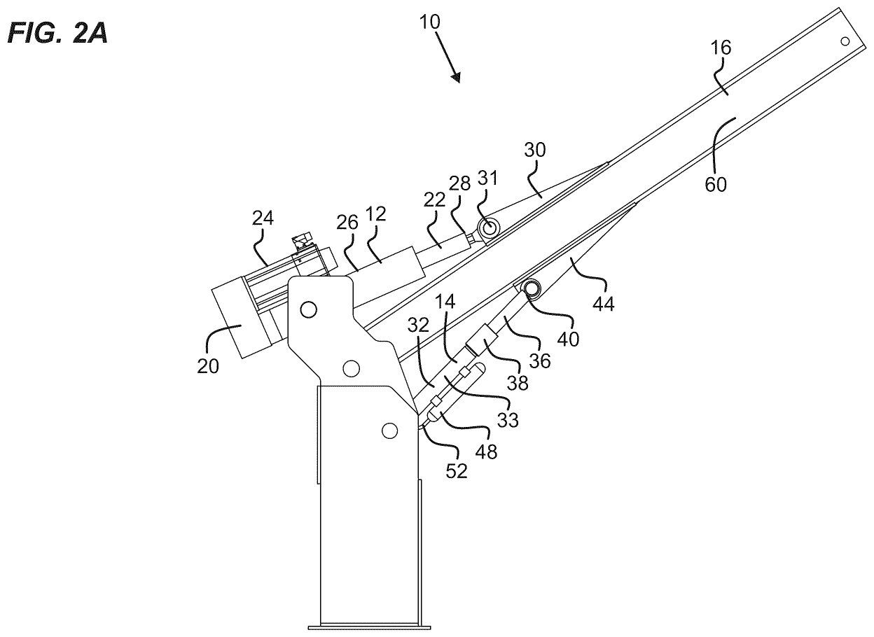

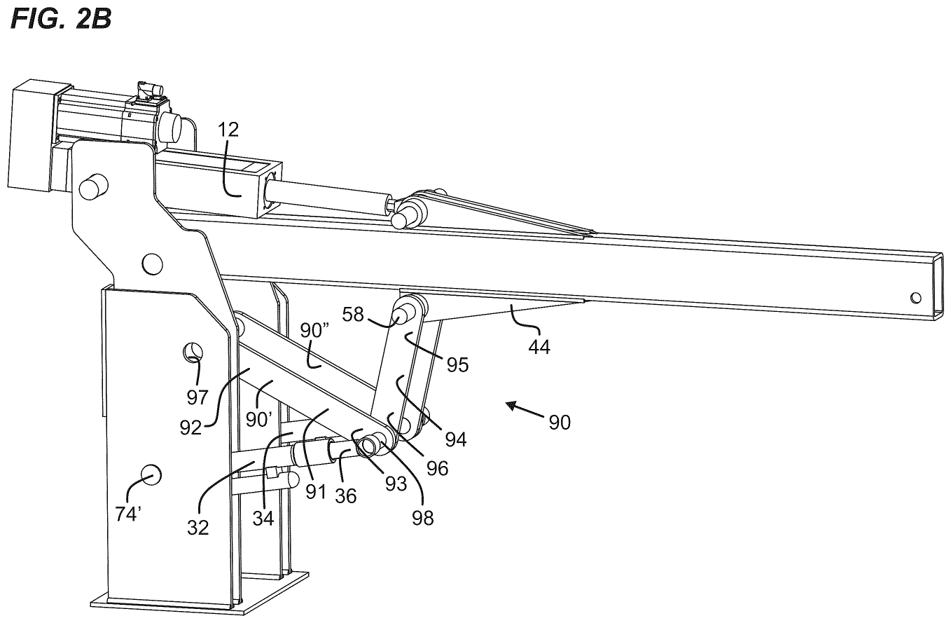

As illustrated, the electric actuator assembly 12 and the pneumatic assist actuator assembly 14 provide forces acting on the boom assembly 16 that are non-parallel. There are several advantages of providing non-parallel forces acting on the boom assembly 16. One advantage is that application of the force by the pneumatic assist actuator assembly 14 can be located to direct a force in a particular manner to provide desired assist that is different from the direction/application of force applied by the electric actuator assembly 12. For example, in the configuration illustrated in FIG. 2, the pneumatic assist actuator assembly 14 is configured as fully retracted and can provide a maximum amount of force on the boom assembly 16 when the greatest force is needed to move the boom assembly 16 when in a lowermost position, for example. As the pneumatic assist actuator assembly extends, the force that it can generate is expected to decrease. FIG. 2A shows the pneumatic assist actuator assembly 14 partially extended. Another advantage is that the location of both the electric actuator assembly 12 and the pneumatic assist actuator assembly 14 can be provided where there is available space. Often, there may be a difficulty in lining up forces so that they are parallel where there is not enough space in a particular application. Accordingly, another advantage of providing the forces as non-parallel is to accommodate space constraints.

The electric actuator assembly 12 includes an actuator gear box 20, an extension rod 22, an actuator motor 24, and an electric actuator housing body 26. In general, the extension rod 22 moves linearly in and out of the electric actuator housing body 26 as a result of power from the actuator motor 24 via the gear box 20. The electric actuator assembly 12 is arranged relative to the boom assembly 16 so that the distal end 28 of the rod 22 attaches to the boom assembly 16 at the electric actuator anchor 30 via electric actuator tie rod 31. In the lifting device 10, the lifting occurs when the extension rod 22 is retracted, and lowering occurs when the extension rod 22 is extended. Of course, the lifting device 10 can be modified so that the electric actuator assembly is below the boom assembly 16. In such a modified arrangement, the lifting can occur when the extension rod 22 is extended, and lowering can occur when the extension rod 22 is retracted.

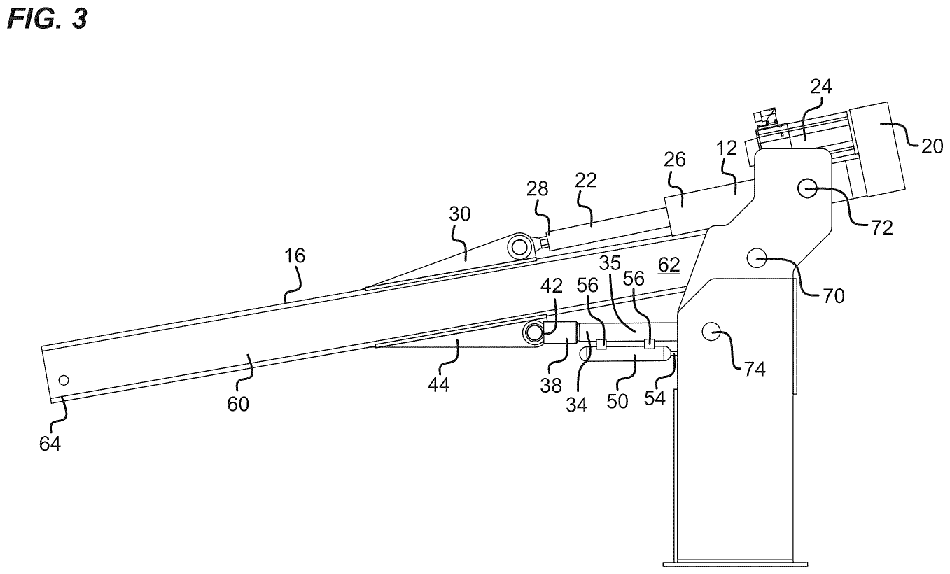

The pneumatic assist actuator assembly 14 includes a pair of pneumatic actuators 32 and 34 having pneumatic cylinder rods 36 (see FIGS. 2A and 3) extending therefrom, and through the gland 38, and arranged to provide a linear movement away from and toward the pneumatic cylinders 33 and 35. The pneumatic cylinder rods 36 have distal ends 40 that attach to the boom assembly 16 at the assist anchor 44. To provide lifting assist, the pneumatic cylinder rods 36 extent during lifting wherein the gas inside the pneumatic cylinders 33 and 35 expands. Additional gas can be provided in the secondary cylinders 48 and 50 which are in fluid communication with the pneumatic actuators 32 and 34 via the lines 52 and 54. The secondary cylinders 48 and 50 can be mounted on the pneumatic actuators 32 and 34 via mounts 56, or they can be mounted separate from the pneumatic actuators 32 and 34. When the boom assembly 16 is lowered, the gas inside the pneumatic actuators 32 and 34 and inside the secondary cylinders 48 and 50 is compressed so that the gas is again available for another lifting of the boom assembly 16.

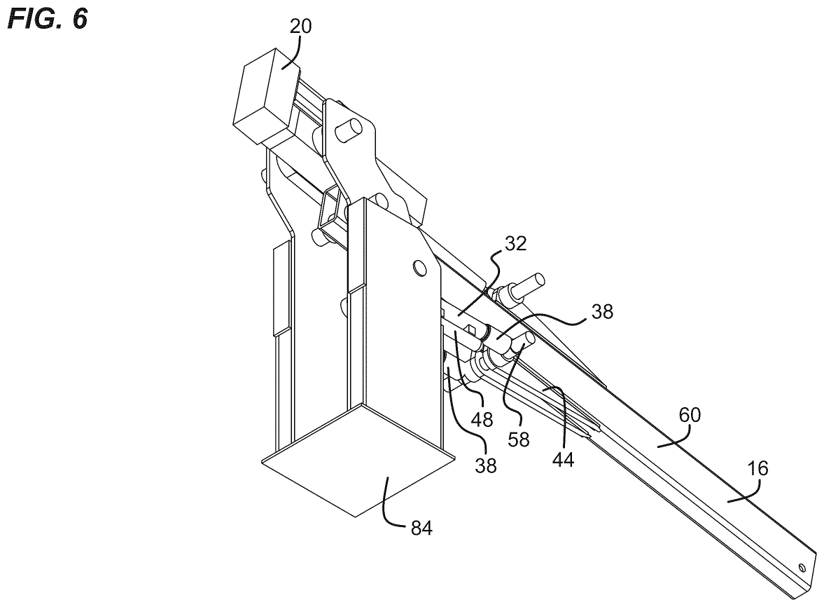

The pneumatic cylinder rods 36 are arranged to attach to a cross tie rod 58 (see FIG. 6) provided as part of the assist anchor 44 and permits the pneumatic cylinder rods 36 to be arranged in parallel.

The boom assembly 16 includes a boom 60 having a proximal end 62 and a distal end 64. The boom distal end 64 can include a load thereon to be lifted or lowered. The load can be provided at any location along the length of the boom 60, but it is expected to be greatest when located at the boom distal end 64. While not illustrated in the figures, a load or an attachment can be located on the boom assembly 16 somewhere along the boom 60 such as at or near the distal end 64. Various attachments that can be attached to the boom 60 include a bucket, a grappler, a hook, a fork, etc. which are well known. In addition, the boom assembly 16 includes an electric actuator anchor 30 and a pneumatic assist anchor 44 to help provide leverage via the electric actuator assembly 12 and the pneumatic actuator assembly 13. The electric actuator anchor 30 provides a location for attachment of the electric actuator assembly 12 thereto, and the pneumatic assist anchor 44 provides a location for attachment of the pneumatic assist actuator assembly 14 thereto. Of course, the electric actuator assembly 12 and the pneumatic assist actuator assembly 14 can be attached at locations that may not be characterized as anchors. An advantage of the anchors 30 and 44 is that they provide a strong structural connection to the boom 60, and also provide a rotation connection that is not within the boom 60 (for example, spaced away from the boom) and that can provide leverage advantage. In addition, a linkage can be provided between the boom 60 (or between the anchors 30 and 44) and the electric actuator assembly 12 and the pneumatic assist actuator assembly 14. An exemplary linkage 90 is illustrated in FIG. 2B and is described below.

The tower or support structure 18 is a base structure or foundation to which the boom assembly 16, the electric actuator assembly 12, and the pneumatic assist actuator assembly 14 attach and which allows for rotation of the boom assembly 16, the electric actuator assembly 12, and the pneumatic assist actuator assembly 14. The boom proximal end 62 attaches to the tower 18 at the boom rotation pin 70, the electric actuator housing body 26 attaches to the tower 18 at the electric actuator housing body pin 72, and the pair of pneumatic cylinders 32 and 34 attach to the tower 18 at the pneumatic cylinder pin 74.

The tower structure 18 as illustrated includes a pair of legs 80 and 82 and a base 84. It is pointed out that the legs 80 and 82 and the base 84 can essentially be part of another structure that provides sufficient support and stability, and they can be fixed in place, if desired. Also, they can be provided as part of another structure that moves such as a vehicle. Examples of structures that can be both fixed in place and moved include vehibles, robots, etc.

Now referring to FIG. 2B, the lifting device 10 is modified to include a linkage 90. The linkage 90 includes a first linkage arm 91 having a first end 92 and a second end 93, and a second linkage arm 94 having a first end 95 and a second end 96. The first linkage arm first end 92 attaches to the tower 18 at the linkage tower pin 97 and the second linkage arm first end 95 attaches to the anchor 44 at the cross tie rod 58. The first linkage arm second end 93 and the second linkage arm second end 96 attach to the pneumatic cylinder rods 36 via the pneumatic cylinder rod pin 98. Also, the pneumatic cylinder pin 74′ can be relocated as illustrated to provide the desired leverage. It should be appreciated that the various described attachment locations for the linkage 90 provide for rotation about the indicated pins. In addition, the length of the first linkage arm 91 and the second linkage arm 94 can be adjusted to provide the desired leverage or advantage. In addition, the described linkage 90 is illustrated as a pair of linkages 90′ and 90″. The linkage 90′ includes the indicated components, and the linkage 90″ can include the same or similar components. Both pneumatic actuators 32 and 34 attach to the pneumatic cylinder pin 74′. It should be appreciated that the linkage 90 can be applied between the pneumatic actuator assembly 14 and the boom assembly 16 as illustrated, and/or between the electric actuator assembly 12 and the boom assembly 16, and that the linkage 90 can be located above or below the boom assembly 16. Furthermore, the location of the various attachment pins can be adjusted to the appropriate location along the tower 18 and/or along the boom assembly 16.

An advantage of the lifting device 10 design depicted in FIGS. 1-8 is that the forces on the boom assembly by the electric actuator and the pneumatic actuator can be arranged to accommodate space limitations, and can also be arranged to take advantage of leverage where the pneumatic actuator provides assist at particular portions of the lifting process. As illustrated, the particular lifting device 10 provide lifting by the pneumatic actuator by retraction and by the pneumatic actuator by extension. Alternative arrangements can be provided. In the embodiment depicted in FIGS. 1-8, the electric actuator assembly is located above the boom, and the pneumatic assist actuator assembly is located below the boom. As alternatives: the electric actuator assembly can be located below the boom and the pneumatic assist actuator assembly can be located above the boom; the electric actuator assembly and the pneumatic assist actuator assembly can both be located below the boom in parallel or not in parallel; the electric actuator assembly and the pneumatic assist actuator assembly can both be located above the boom in parallel or not in parallel; the electric actuator assembly and the pneumatic assist actuator assembly can be located alongside the boom in parallel or not in parallel; and one of the electric actuator assembly or the pneumatic assist actuator assembly can be located alongside the boom and the other of the electric actuator assembly or the pneumatic assist actuator assembly can be located above or below the boom. These configurations can be selected based on space availability considerations and also based on force distribution considerations. Regarding force distribution considerations, one skilled in the art would understand how to adjust a load distribution to a more favorable outcome for a give load, boom, and range of movement of the boom, by selecting for placement of the electric actuator assembly and the pneumatic assist actuator assembly. The load distribution can be considered the relationship between the angle of the boom as a function of work (for example, horsepower).

### Alternative Embodiments

In the following described alternative embodiments, the various components of the lifting devices can be essentially the same or similar to those depicted and described in connection with FIGS. 1-8, and various components are placed at different locations for advantage.

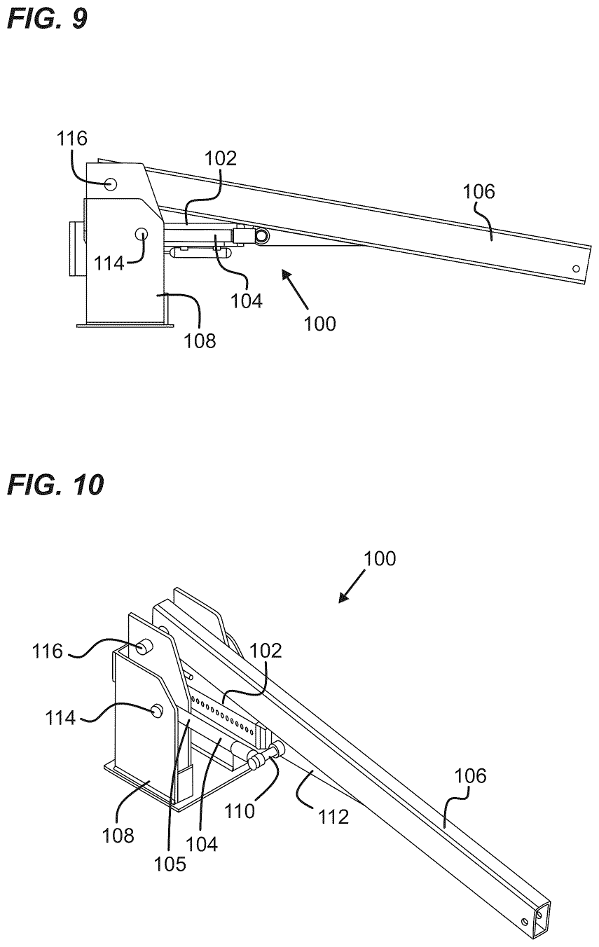

A first alternative arrangement is depicted in FIGS. 9 and 10 where the lifting or lowering device 100 includes an electric actuator assembly 102 and a pneumatic actuator assembly 104 arranged in parallel below the boom assembly 106. In this arrangement, the electric actuator assembly 102 and the pneumatic actuator assembly 104 provide forces that act in parallel on the boom assembly 106. It can be seen that both the electric actuator assembly 102 and the pneumatic actuator assembly 104 attach to the boom assembly at the tie rod 110 that attaches to the boom anchor 112, and also to the tower 108 at the pin 114, and the boom assembly attaches to the tower 108 at the pin 116. As a result, extension of both the electric actuator assembly 102 and the pneumatic actuator assembly 104 provide lifting of the boom assembly 106, and retraction of both the electric actuator assembly 102 and the pneumatic actuator assembly 104 provide lowering of the boom assembly 106. In addition, the pneumatic actuator assembly 104 includes both a first pneumatic actuator 105 and a second actuator (not shown) arranged in parallel. The first and second pneumatic actuators can be similar to the first and second pneumatic actuators 32 and 34 depicted, for example in FIGS. 2 and 3.

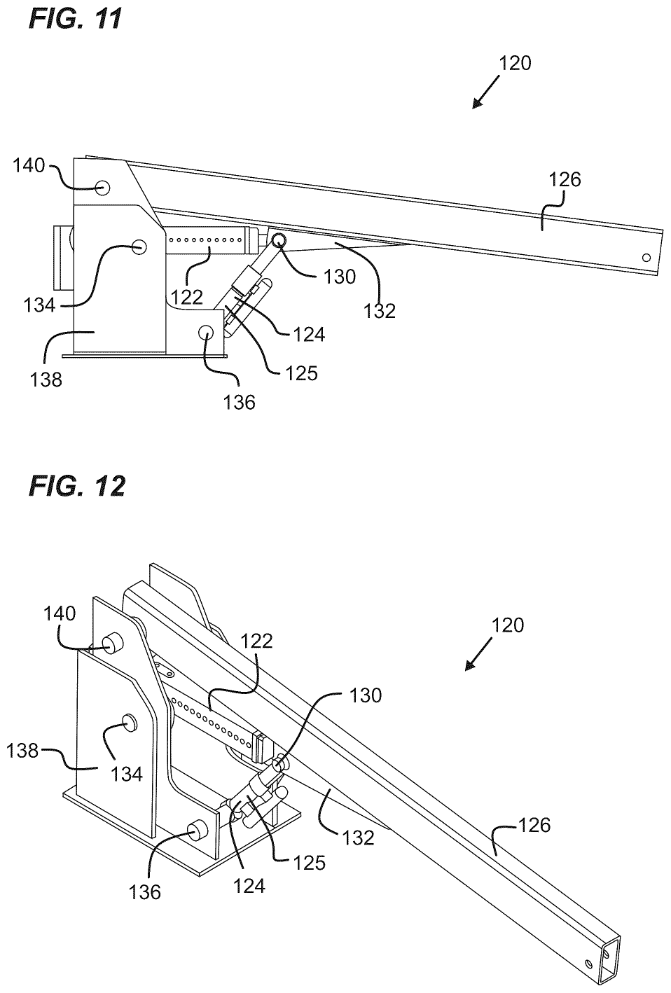

A second alternative arrangement of a lifting device 120 is depicted in FIGS. 11 and 12. This lifting device 120 is similar to the lifting device 100 in that the electric actuator assembly 122 and the pneumatic actuator assembly 124 are located below the boom assembly 126 so that they both provide extension force for lifting, but they are offset in their forces acting on the boom assembly 126. In this arrangement, the electric actuator assembly 122 and the pneumatic actuator assembly 124 provide forces that act non-parallel on the boom assembly 106. It can be seen that both the electric actuator assembly 122 and the pneumatic actuator assembly 124 attach to the boom assembly 126 at the tie rod 130 that attaches to the boom anchor 132, but attach to the tower 138 at different locations. The electric actuator assembly 122 attaches to the tower 138 at the pin 134, and the pneumatic actuator assembly attaches to the tower 138 at the pin 136. Also, the boom assembly 126 rotatably attaches to the tower 138 at the pin 140. As a result, extension of both the electric actuator assembly 122 and the pneumatic actuator assembly 124 provide lifting of the boom assembly 126, and retraction of both the electric actuator assembly 122 and the pneumatic actuator assembly 124 provide lowering of the boom assembly 126. The pneumatic actuator assembly 124 includes a first pneumatic actuator 125 and a second pneumatic actuator (not shown but in parallel with the first pneumatic actuator 125). The first and second pneumatic actuators can be similar to the first and second pneumatic actuators 32 and 34 depicted, for example, in FIGS. 2 and 3.

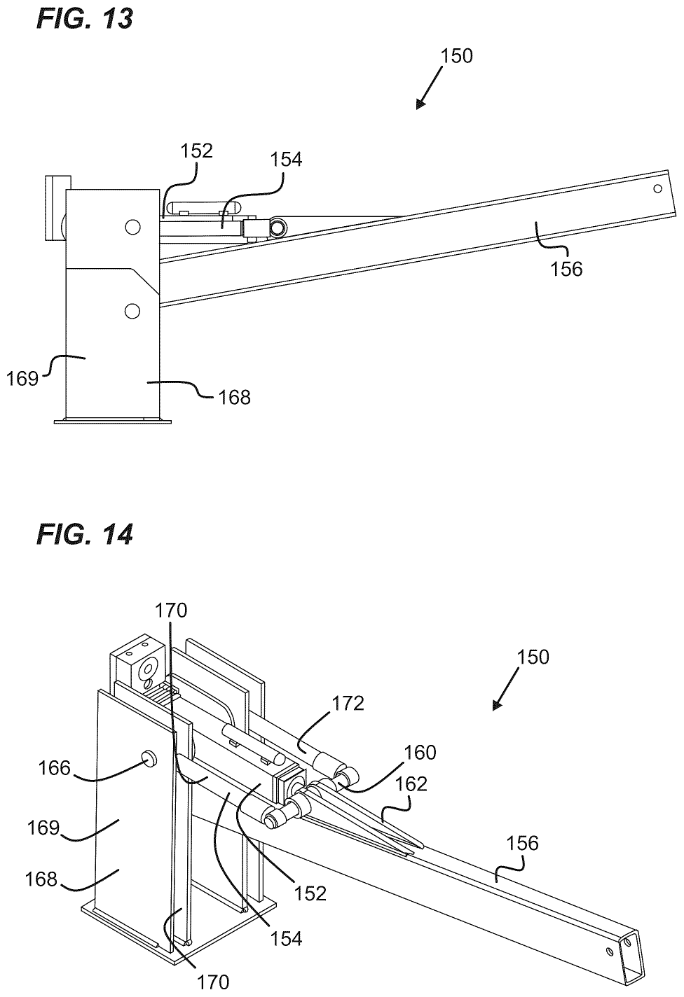

A third alternative arrangement of a lifting device 150 is depicted in FIGS. 13 and 14. This lifting device 150 is similar to the lifting device 100 except that both the electric actuator assembly 152 and the pneumatic actuator assembly 154 are located above the boom assembly 156 so that they both provide extension force for lowering and a retraction force for lifting, and they are arranged in parallel but, if desired, they can be adjusted so that they are not in parallel similar to the configuration illustrated in, for example, FIGS. 11 and 12, to provide an offset in forces acting on the boom assembly. It can be seen that both the electric actuator assembly 152 and the pneumatic actuator assembly 154 attach to the boom assembly 156 at the tie rod 160 that attaches to the boom anchor 162. As illustrated, both the electric actuator assembly 152 and the pneumatic actuator assembly 154 attach to the tower 168 at the combination electric actuator and pneumatic actuator pin 166. Of course, the electric actuator assembly 152 and the pneumatic actuator assembly 154 can be attached to the tower 168 at separate locations to provide an offset in forces applied by the electric actuator assembly 152 and the pneumatic actuator assembly 154 as illustrated, for example, in FIGS. 11 and 12, but in application above the boom assembly 156. The boom assembly 156 rotatably attaches to the tower 168 via a pin in a manner similar to earlier described embodiments even if not illustrated in FIGS. 13 and 14 due to the presence of the outer tower wall 169 which hides the pin which attaches to the inner tower wall 170. As a result, extension of both the electric actuator 152 and the pneumatic actuator 154 provide a lowering force on the boom assembly 156 when extending, and provide a lifting force on the boom assembly 156 when retracting. In addition, the pneumatic actuator assembly 154 includes a first pneumatic actuator 170 and a second pneumatic actuator 172 arrangement in parallel, and both attach to the tie rod 160 on opposite sides of the electric actuator assembly 152.

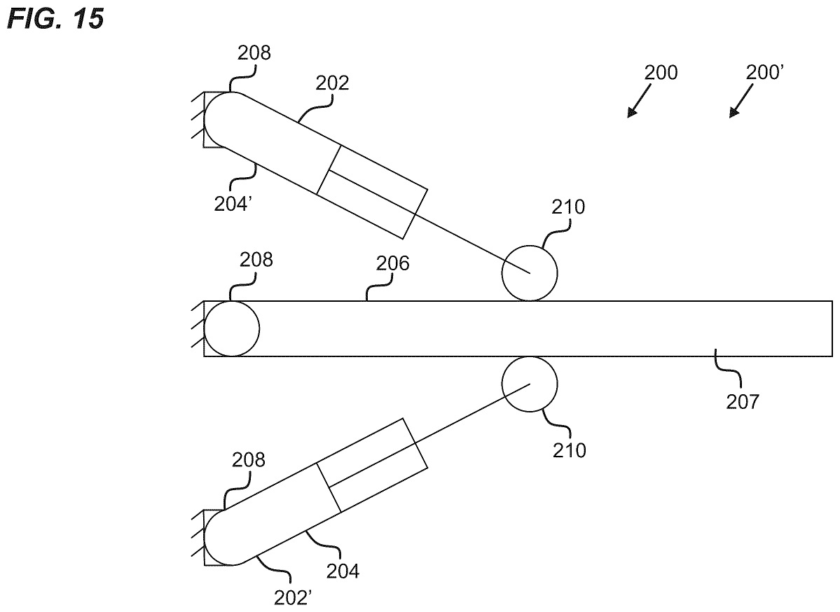

It should be appreciated that embodiments herein have illustrate a single electric actuator and two pneumatic actuators. It should be appreciated that the electric actuator assembly can include any number of electric actuators, and the pneumatic actuator assembly can also include any number of electric actuators. The number of electric actuators and pneumatic actuators can be selected based on the load needs for a particular application and the space available in a particular design location for placement of the various actuators. For example, there can be 1, 2, 3, 4, 5, 6, 7, 8, etc. electric actuators, and there can be 1, 2, 3, 4, 5, 6, 7, 8, etc. pneumatic actuators Now referring to FIG. 15, a fourth alternative embodiment and a fifth alternative embodiment of a lifting and/or lowering devices 200 and 200′ are illustrated. In the fourth alternative embodiment, the lifting and/or lowering device 200 includes an electric actuator assembly 202, a pneumatic actuator assembly 204, and a boom assembly 206. As illustrated the electric actuator assembly 202, a pneumatic actuator assembly 204, and a boom assembly 206 each have a first end 208 attached to another structure, such as a tower, that holds them in place, and the electric actuator assembly 202 and the pneumatic actuator assembly 204 have a second end 210 attached to the boom assembly 206. The second ends 210 can attach directly to the boom member 207 or to an anchor provided as part of the boom assembly 206 as described previously and/or via a linkage as described previously. Thus, in the fourth alternative embodiment, the electric actuator assembly 202 is located above the boom assembly 206 and the pneumatic actuator assembly 204 is located below the boom assembly 206. A lifting of the boom assembly 206 occurs when the electric actuator assembly 202 retracts and the pneumatic actuator assembly 204 extends. In the fifth alternative embodiment, the lifting and/or lowering device 200′ includes an electric actuator assembly 202′, a pneumatic actuator assembly 204′, and a boom assembly 206. A lowering of the boom assembly 206 occurs when the electric actuator assembly 202′ retracts and the pneumatic actuator assembly 204′ extends.

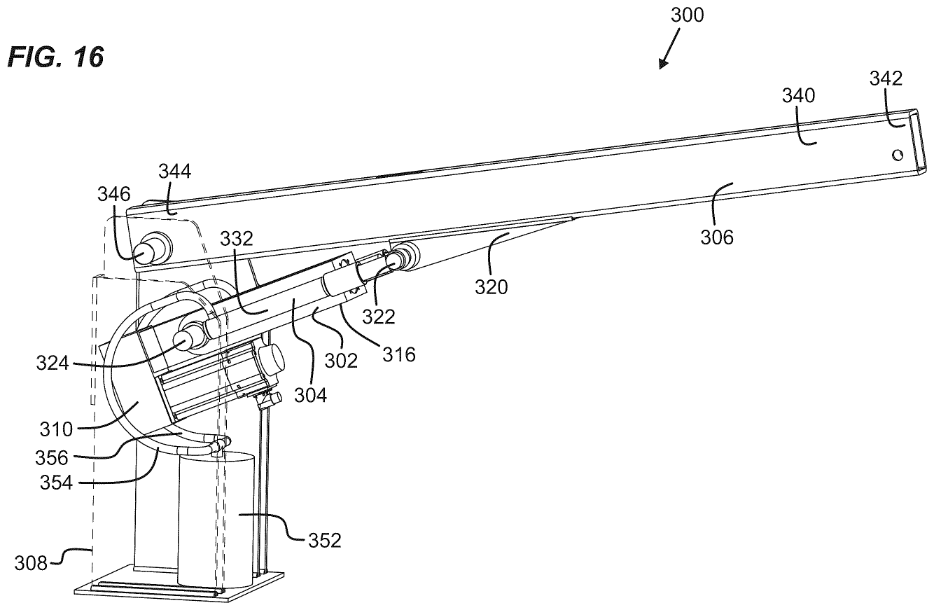

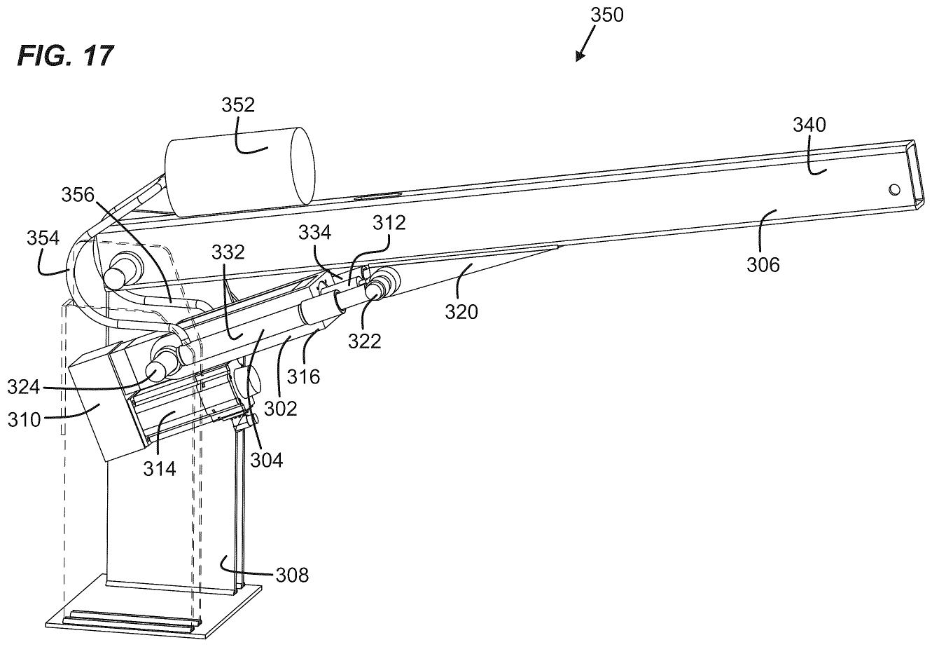

Now referring to FIGS. 16 and 17, sixth and seventh embodiments of a lifting and lowering devices 300 and 350 are illustrated. Both devices can include similar components but certain components can be arranged differently to accommodate or take advantage of space constraints or space availability. Both devices include an electric actuator assembly 302, a pneumatic actuator assembly 304, a boom assembly 306, and a tower assembly 308. Portions of the tower assembly 308 are illustrated with broken lines to show otherwise hidden structure or structure obstructed from view. The electric actuator assembly 302 includes an actuator gear box 310, an extension rod 312, actuator motor 314, and an electric actuator housing body 316. The electric actuator assembly 302 attaches to the boom anchor 320 via the boom anchor pin or tie rod 322, and attaches to the tower assembly 308 via the tower pin or tie rod 324. The pneumatic actuator assembly 304 includes a pair of pneumatic actuators 332 and 334, and each includes a pneumatic cylinder rod 336, a gland 338 at the end of each pneumatic actuator 332 and 334 and through which the pneumatic cylinder rod 336 extends. As illustrated the pneumatic actuators 332 and 334 rotatably attach to the tower assembly 308 via the tower pin or tie rod 324, and both pneumatic cylinder rods 336 attach to the boom anchor 320 via the boom anchor pin or tie rod 322. Furthermore, the boom assembly 306 includes a boom 340 having a first end 342 for receiving a load for lifting and lowering, and a second end 344 rotatably connected to the tower assembly 308 via the boom pin or tie rod 346.

As illustrated in both FIGS. 16 and 17, the additional gas cylinders or secondary cylinders 352, which are part of the pneumatic actuator assembly 304, can be provided and located in alternative places compared to, for example, FIG. 1, where the secondary cylinder 48 is illustrated as attached to the pneumatic actuator 32. In general, the secondary cylinder provides additional gas for operation of the pneumatic actuator assembly and can be located attached to or remote from the other components of the pneumatic actuator assembly except that there is provided a line for fluid connection between the secondary cylinder and the pneumatic actuator. As illustrated in FIG. 16, the secondary cylinder 352 is located spaced from the pneumatic actuators 332 and 334, below the pneumatic actuators 332 and 334, and within the tower assembly 308. Lines 354 and 356 attach from the secondary cylinder 352 to the pneumatic actuators 332 and 334, respectively. In FIG. 17, the secondary cylinder 352 is located spaced from the pneumatic actuators 332 and 334, above the pneumatic actuators 332 and 334, and resting on top of the boom assembly 306 or on the boom 340. It should be appreciated that the size of the secondary cylinder 352 can be altered based on the gas powering needs of the pneumatic actuator assembly 304, the number of secondary cylinders 352 can be selected based on the size needs and the possibility of located the secondary cylinders in various locations. For example, an alternative device can be provided where secondary cylinders are located both within the tower and on top of the boom assembly, or elsewhere where space can be found, to power the pneumatic actuator assembly.

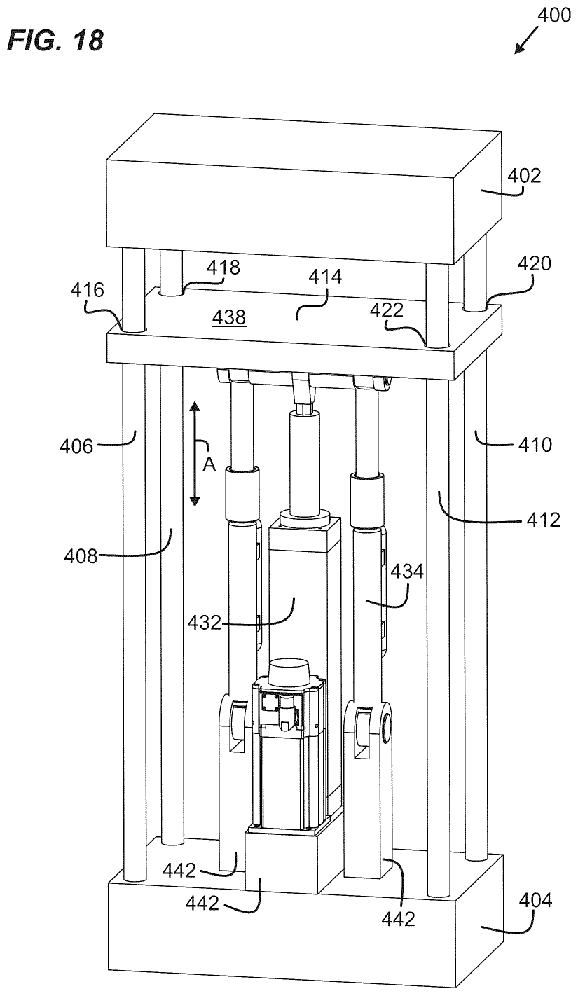

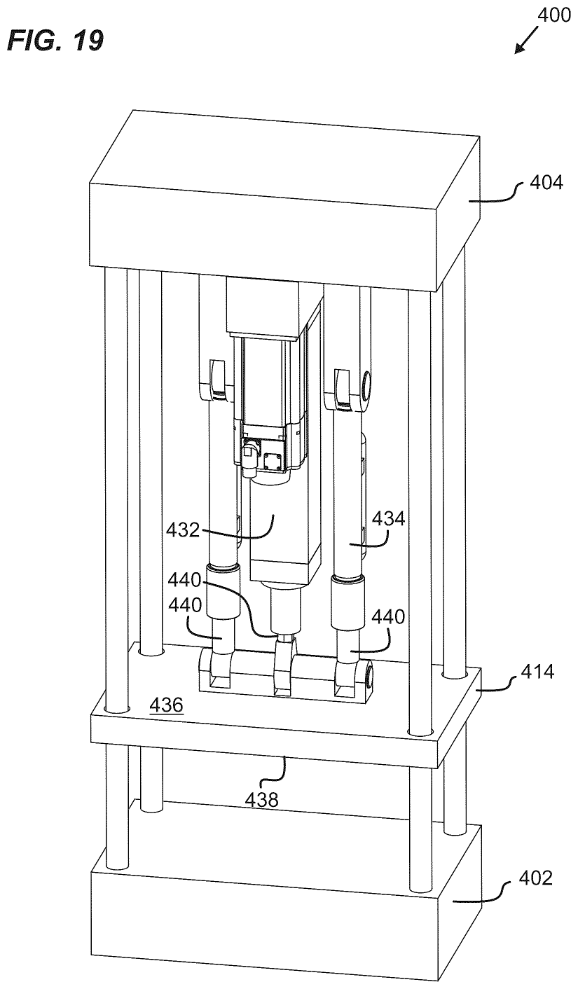

An alternative embodiment of a compression device is illustrated in FIGS. 18 and 19 and indicated at reference number 400. While the device can be referred to as a compression device for compression various items, such as, for example, carboard boxes or other packaging material, and trash, it should be appreciated that the device 400 can also be utilized as a lifting and/or lowering device. The device includes a first fixed platform 402 and a second fixed platform 404, and guide rods 406, 408, 410, and 412 extending between the first fixt platform 402 and the second fixed platform 404. A moveable platform 414 is arranged to move in a direction between (toward or away from) each of the first fixed platform 402 and the second fixed platform 404, and is constrained to move in the indicated directions by the guide rods which extend through the openings or receivers 416, 418, 420, and 422. The direction of movement is indicated by double arrow A. An electric actuator assembly 432 and a pneumatic actuator assembly 434 are available for moving the moveable platform 414 in the directions to and from each of the first fixed platform 402 and the second fixed platform 404. The moveable platform 414 includes a first surface 436 and a second surface 438. Although not shown, the pneumatic actuator assembly 434 can include one or more secondary cylinders to provide additional pressurized gas for operating the pneumatic actuator assembly 434. Each of the electric actuator assembly 432 and the pneumatic actuator assembly 434 have a first end 440 that attaches to the first surface 436 of the moveable platform 414, and a second end 442 that attaches to the second fixed platform 404.

The device 400 can be considered different from the alternative lifting and lowering devices by not including a lever or boom assembly. Instead, the device 400 can provide for extension and/or compression in any direction. That is, the extension and/or compression force of the electric actuator assembly 432 and the pneumatic actuator assembly 434 can be directed upwardly, downwardly, or in any other direction where there is a need for a force in a direction indicated by the arrow A, where the device can be oriented in any direction. The force can also be characterized as a pushing action when the force is in extension, and the pushing action can be provided in any desired direction. Similarly, the device 400 can provide a pulling action when the force is in retraction, and the device can be arranged or configured to provide the pulling action in any direction.

It should be appreciated that the fixed platforms can be considered floors, staging, or locations where something can be delivered to or located at, and there is no requirement, unless indicated, that the platform includes a continuous surface. That is, there may be openings through the fixed platform allowing something to be delivered though or passed through the platform. Of course, the fixed platform can be a barrier preventing articles from passing therethrough, if desired. Accordingly, the device 400 can be used to deliver articles to a location. Similarly, the movable platform can be a support or structure or facing that delivers articles to another location.

### Following Comments

The described device can be used for raising and lowering of a crane boom or any other type of boom that may be used in construction site, a factory, a warehouse, etc, and can be used for providing extension, compression, compaction, or retraction. In general, the type of application favorably suited for the use of the device is when the load is relatively constant and the movement, including the length of the movement, is repetitive. The electric actuator can include an electric actuator of planetary roller screw, ball screw, or other variety, with a mounting structure pivotally mounted on the base of the crane, and an additional mounting structure pivotally mounted to the boom of the crane; a motor mounted to the electric actuator; a gear box that connects the electric actuator to the motor to activate the electric actuator upon actuation of the motor resulting in the movement of the crane boom. The pneumatic can include a mounting structure pivotally mounted to the base of the crane, an additional mounting structure pivotally mounted to the boom of the crane, and an external reservoir that can be manipulated to control the volume of the accumulator.

While the invention has been described in complete detail and pictorially shown the provided drawings, it is not to be limited to such details, since many changes and modifications may be made to the invention without departing from the spirit and scope thereof. Hence, it is described to cover any and all modification and forms, which may come within the language and scope of the appended claims.

What is claimed is:

1. A lifting and lowering device comprising:
(a) a tower assembly and a boom assembly extending from the tower assembly and configured to rotate relative to the tower assembly;
(b) an electric actuator assembly comprising an electric actuator housing body and an extension rod extending from the actuator housing body and configured to extend and retract from the actuator housing body, wherein the electric actuator assembly attaches to the tower assembly and the boom assembly to provide the rotation of the boom assembly relative to the tower assembly; and
(c) a pneumatic actuator assembly comprising a pneumatic actuator and a rod extending from the pneumatic actuator and configured to extend and retract from the pneumatic actuator, wherein the pneumatic actuator assembly attaches to the tower assembly and the boom assembly to provide rotation of the boom assembly relative to the tower assembly.

2. A lifting and lowering device according to claim 1, wherein:
(a) the pneumatic actuator assembly is located below the boom assembly and the electric actuator assembly is located above the boom assembly.

3. A lifting and lowering device according to claim 1, wherein:
(a) the pneumatic actuator assembly is located above the boom assembly and the electric actuator assembly is located below the boom assembly.

4. A lifting and lowering device according to claim 1, wherein:
(a) the pneumatic actuator assembly and the electric actuator assembly are located below the boom assembly and are configured to act on the boom assembly in parallel.

5. A lifting and lowering device according to claim 1, wherein:
(a) the pneumatic actuator assembly and the electric actuator assembly are located below the boom assembly and are configured to act on the boom assembly in a non-parallel arrangement.

6. A lifting and lowering device according to claim 1, wherein:
(a) the pneumatic actuator assembly and the electric actuator assembly are located above the boom assembly and are configured to act on the boom assembly in parallel.

7. A lifting and lowering device according to claim 1, wherein:
(a) the pneumatic actuator assembly and the electric actuator assembly are located above the boom assembly and are configured to act on the boom assembly in a non-parallel arrangement.

8. A lifting and lowering device according to claim 1, further comprising:
(a) a linkage extending the pneumatic actuator assembly to the boom assembly.

9. A lifting and lowering device according to claim 1, wherein:
(a) the pneumatic actuator assembly comprises at least two pneumatic actuators arranged in parallel.

10. A compression device comprising:
(i) a first location, a second location, and a moveable platform configured to move along an axis extending from the first location to the second location;
(ii) an electric actuator assembly comprising an electric actuator housing body and an extension rod extending from the actuator housing body and configured to extend and retract from the actuator housing body, wherein the electric actuator assembly is configured to move the moveable platform toward one of the first location or the second location; and
(iii) a pneumatic actuator assembly comprising a pneumatic actuator and a rod extending from the pneumatic actuator and configured to extend and retract from the pneumatic actuator, wherein the pneumatic actuator assembly is configured to move the moveable platform toward one of the first location or the second location.

11. A compression device according to claim 10 further comprising:
(a) at least one guide rod, and wherein the moveable platform is configured to move along the at least one guide rod.

12. A compression device according to claim 10 further comprising:
(a) multiple guide rods arranged in parallel, wherein the moveable platform is configured to move along the multiple guide rods, and wherein the multiple guide rods extend in a direction from the first location to the second location.

13. A method of lifting and/or lowing an article using a combination of an electric actuator and a pneumatic actuator comprising:
(a) actuating an electric actuator assembly and a pneumatic actuator assembly to cause a boom assembly to rotate a boom assembly relative to a tower assembly.

14. A method according to claim 13 wherein:
(a) the electric actuator assembly comprises an electric actuator housing body and an extension rod extending from the actuator housing body and configured to extend and retract from the actuator housing body, wherein the electric actuator assembly attaches to the tower assembly and the boom assembly to provide the rotation of the boom assembly relative to the tower assembly; and
(c) the pneumatic actuator assembly comprises a pneumatic actuator and a rod extending from the pneumatic actuator and configured to extend and retract from the pneumatic actuator, wherein the pneumatic actuator assembly attaches to the tower assembly and the boom assembly to provide rotation of the boom assembly relative to the tower assembly.

15. A method according to claim 13, wherein:
(a) the pneumatic actuator assembly is located below the boom assembly and the electric actuator assembly is located above the boom assembly.

16. A method according to claim 13, wherein:
(a) the pneumatic actuator assembly is located above the boom assembly and the electric actuator assembly is located below the boom assembly.

17. A method according to claim 13, wherein:
(a) the pneumatic actuator assembly and the electric actuator assembly are located below the boom assembly and are configured to act on the boom assembly in parallel.

18. A method according to claim 13, wherein:
(a) the pneumatic actuator assembly and the electric actuator assembly are located below the boom assembly and are configured to act on the boom assembly in a non-parallel arrangement.

19. A method according to claim 13, wherein:
(a) the pneumatic actuator assembly and the electric actuator assembly are located above the boom assembly and are configured to act on the boom assembly in parallel.

20. A method according to claim 13, wherein:
(a) the pneumatic actuator assembly and the electric actuator assembly are located above the boom assembly and are configured to act on the boom assembly in a non-parallel arrangement.

21. A method of lifting, lowering, or compressing an article comprising:
(a) actuating an electric actuator assembly and a pneumatic actuator assembly to cause a moveable platform to move along an axis extending from a first location toward a second location.

22. A method according to claim 21 wherein:
(a) the electric actuator assembly comprises an electric actuator housing body and an extension rod extending from the actuator housing body and configured to extend and retract from the actuator housing body, wherein the electric actuator assembly is configured to move the moveable platform toward one of the first location or the second location; and
(c) a pneumatic actuator assembly comprising a pneumatic actuator and a rod extending from the pneumatic actuator and configured to extend and retract from the pneumatic actuator, wherein the pneumatic actuator assembly is configured to move the moveable platform toward one of the first location or the second location.

23. A method according to claim 21 further comprising:
(a) at least one guide rod, and wherein the moveable platform is configured to move along the at least one guide rod.

24. A method according to claim 21 further comprising:
(a) multiple guide rods arranged in parallel, wherein the moveable platform is configured to move along the multiple guide rods, and wherein the multiple guide rods extend in a direction from the first location to the second location.
